(19) United States
(12) Patent Application Publication
(10) Pub. No.: US 2007/0099083 A1
(43) Pub. Date: May 3, 2007

(54) Alkaline battery

(75) Inventor: Hisanori Sugahara, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/590,844

(22) Filed: Nov. 1, 2006

(30) Foreign Application Priority Data
Nov. 2, 2005 (JP) 2005-319355

(51) Int. Cl. H01M 4/42; H01M 4/62; H01M 4/50; H01M 10/26

(52) U.S. Cl. 429/229; 429/232; 429/224; 429/206

(57) ABSTRACT

An alkaline battery according to the present invention is provided with a positive electrode, a negative electrode, and an alkaline electrolyte solution. The negative electrode contains zinc alloy powder, a gelling agent, and an alkaline electrolyte solution. The zinc alloy powder is constituted by a zinc alloy containing 600 to 3000 ppm of aluminum. The zinc alloy powder contains particles with a particle size of 75 μm or less, in a mass ratio of 10 to 40 mass % of all the particles. Furthermore, it is preferable that the negative electrode further contains an indium compound.

### BACKGROUND OF THE INVENTION

1. Field of the Invention

The present invention relates to an alkaline battery having excellent discharge characteristics.

2. Description of the Related Art

In recent years, as portable equipment with a high current consumption has been developed, it is required to develop batteries with a long life. It is necessary to make the discharge life of batteries as long as possible, in particular, in high-rate discharge (high-current discharge), and thus it is required to reduce the internal resistance during discharge. Furthermore, the most direct approach for making the discharge duration long is to increase the amount of an active material inside the batteries, but the size of each of the batteries is regulated, and thus there is a limitation in increasing the amount of the active material.

Currently, as primary batteries used for portable equipment, alkaline manganese batteries are used widely. Alkaline manganese batteries usually are provided with: a positive electrode containing an electrolytic manganese dioxide as a positive electrode active material, and graphite as an auxiliary material for reducing the electrical resistance; a negative electrode containing zinc alloy powder as a negative electrode active material, and a gelled alkaline electrolyte solution (containing 30 to 40 mass % of KOH); and an alkaline electrolyte solution containing zinc oxide.

In these alkaline manganese batteries, in order to improve the battery characteristics during high-rate discharge, for example, it has been proposed to atomize a zinc alloy used as a negative electrode active material (JP 2001-512284A (Tokuhyo)). According to JP 2001-512284A (Tokuhyo), zinc alloy powder in the form of fine particles has a large specific surface area, and thus when batteries are formed using this zinc alloy powder in a negative electrode, it is possible to improve the battery characteristics during high-rate discharge.

However, in conventional alkaline batteries in which zinc alloy powder is used in a negative electrode, as discharge progresses, zinc oxide with a low conductivity is generated on the surface of the zinc alloy powder, and this zinc oxide inhibits a discharge reaction of the zinc alloy serving as a negative electrode active material, so that the zinc alloy cannot sufficiently contribute to a discharge reaction. The problem that a discharge reaction of a zinc alloy is inhibited by such zinc oxide being generated is significant in particular when a zinc alloy powder with a large specific surface area is used.

### SUMMARY OF THE INVENTION

An alkaline battery of the present invention includes a positive electrode, a negative electrode, and an alkaline electrolyte solution, wherein the negative electrode contains zinc alloy powder, a gelling agent, and an alkaline electrolyte solution, the zinc alloy powder is constituted by a zinc alloy containing 600 to 3000 ppm of aluminum, and the zinc alloy powder contains particles with a particle size of 75 μm or less, in a mass ratio of 10 to 40 mass % of all the particles.

According to the present invention, it is possible to provide an alkaline battery having excellent discharge characteristics, more specifically, an alkaline battery in which the discharge life is long even when high-rate discharge is performed. More specifically, in the alkaline battery according to the present invention, fine zinc alloy powder containing aluminum in the above-described specific amount and having the above-described specific granularity is used in the negative electrode, and thus it is possible to suppress the phenomenon that zinc oxide generated during discharge inhibits a discharge reaction of a zinc alloy. Accordingly, the utilization ratio of the zinc alloy is increased. Thus, the discharge characteristics during high-rate discharge can be improved, and a long discharge life can be realized.

### BRIEF DESCRIPTION OF THE DRAWINGS

FIG. 1 is a partial cross-sectional view of an alkaline battery fabricated in Example 1.

### DESCRIPTION OF THE PREFERRED EMBODIMENTS

An alkaline battery according to the present invention is provided with a positive electrode, a negative electrode, a separator that is disposed between the positive electrode and the negative electrode, and an alkaline electrolyte solution. The negative electrode is constituted as a gelled negative electrode containing zinc alloy powder, a gelling agent, and an alkaline electrolyte solution. A zinc alloy constituting the zinc alloy powder acts as a negative electrode active material. The zinc alloy powder is constituted by a zinc alloy containing 600 to 3000 ppm of aluminum as an alloying element. Furthermore, the zinc alloy powder contains particles with a particle size of 75 μm or less, in a mass ratio of 10 to 40 mass % of all the particles. By using the zinc alloy powder, the discharge characteristics of the alkaline battery can be improved, and in particular, the discharge life during high-rate discharge can be made long.

As described above, in an alkaline battery in which zinc alloy powder is used in a negative electrode, zinc oxide is generated on the surface of the zinc alloy powder during discharge, and thus a discharge reaction of the zinc alloy is inhibited. However, when fine zinc alloy powder having the above-described specific granularity is constituted by a zinc alloy containing aluminum in the above-described specific amount as an alloying element, it is possible to suppress occurrence of this phenomenon wherein a discharge reaction is inhibited. Accordingly, the utilization ratio of the zinc alloy is increased, and thus the discharge characteristics of the battery can be improved.

It is considered that when aluminum is used as an alloying element in the zinc alloy constituting the zinc alloy powder, zinc in a crystal of zinc oxide, generated during discharge, partially is substituted with aluminum whose valence is higher by one than that of zinc, and thus a large number of conductive electrons can be generated inside the crystal, so that the conductivity of the zinc oxide is improved. The discharge characteristics of the alkaline battery presumably are improved by this effect of improving the conductivity of zinc oxide generated on the surface of the zinc alloy powder.

The content of aluminum in the zinc alloy constituting the zinc alloy powder is 600 ppm or more, preferably 1000 ppm or more, and 3000 ppm or less, preferably 2000 ppm or less. If the content of aluminum in the zinc alloy is too small, then an effect of improving the conductivity of zinc oxide generated during discharge is not sufficiently exerted, and thus the utilization ratio of the zinc alloy cannot be increased. If the content of aluminum in the zinc alloy is too large, then the amount of gas generated from the zinc alloy powder increases inside the battery, and thus the preserving property is lowered, so that, for example, there is a problem in that the discharge characteristics after the battery is held for a long period at a relatively high temperature (approximately 60° C., for example) are deteriorated. Herein, in the present invention, the unit “ppm” is used as a mass-based unit of the content.

The zinc alloy constituting the zinc alloy powder may contain an alloying element other than zinc or aluminum. In particular, when a material such as indium or bismuth is contained, even if the reaction area is increased by atomizing zinc alloy powder as in the present invention, it is possible to suppress a reaction with the electrolyte solution, thereby preventing gas from being generated. Regarding the content of indium or bismuth in the zinc alloy, the content of indium preferably is 50 to 500 ppm, and the content of bismuth preferably is 50 to 500 ppm, for example. The content of the alloying elements in the zinc alloy can be measured using an ICP mass analysis method or the like.

Regarding the granularity of the zinc alloy powder, the ratio of particles with a particle size of 75 μm or less is 10 mass % or more, preferably 20 mass % or more, and 40 mass % or less, preferably 35 mass % or less, in mass ratio with respect to all the particles. When such a fine zinc alloy powder is used, it is possible to improve the discharge characteristics, in particular, the high-rate discharge characteristics of the alkaline battery. If the ratio of particles with a particle size of 75 μm or less is too low, then the effect of improving the conductivity of zinc oxide is not exerted even when aluminum is contained in the zinc alloy. If the ratio of particles with a particle size of 75 μm or less is too high, then the amount of gas generated from the zinc alloy powder increases inside the battery, and thus the preserving property is lowered, so that, for example, there is a problem in that the discharge characteristics after the battery is held for a long period at a relatively high temperature (approximately 60° C., for example) are deteriorated.

Herein, in the present invention, the particle size of the zinc alloy powder refers to the particle size based on a classification using a sieve. More specifically, the phrase “particles with a particle size of 75 μm or less” refers to particles that can pass through a standard sieve with openings of 75 μm on a side. Accordingly, the zinc alloy powder used in the present invention may be prepared such that particles that can pass through a standard sieve with openings of 75 μm on a side are contained within a range of 10 mass % or more, preferably 20 mass % or more, and 40 mass % or less, preferably 35 mass % or less, in mass ratio with respect to all the particles. Furthermore, the maximum diameter of the zinc alloy powder contained in the negative electrode preferably is approximately 400 to 500 μm, and the minimum diameter preferably is approximately 10 μm. Herein, the maximum diameter and the minimum diameter of the zinc alloy powder are the maximum value and the minimum value of values obtained by measuring the length of the shorter diameter (diameter that is perpendicular to the longest diameter in the powder) of the zinc alloy powder based on a photograph obtained by observing the zinc alloy powder using an electron microscope, and by averaging such lengths.

Furthermore, the negative electrode according to the present invention preferably contains an indium compound. In a battery in which zinc alloy powder constituted by a zinc alloy with a large content of aluminum is used in a negative electrode, for example, when the battery is discharged under a light load, a conductive reaction product (dendrite) abnormally is precipitated during the discharge, and the reaction product is brought into contact with the battery can, thereby causing an internal short circuit, so that the discharge duration of the battery, that is, the life of the battery may become extraordinarily short. However, when the negative electrode contains an indium compound, due to an ion exchange reaction of the indium compound, indium is segregated on the surface of the zinc alloy powder, and thus it is possible to prevent the discharge characteristics from being deteriorated by the internal short circuit. The reason for this presumably is that indium segregated on the surface of the zinc alloy powder suppresses generation of dendrite from the zinc alloy powder. Furthermore, when the indium compound is added to the negative electrode, it also is possible to suppress generation of gas inside the battery.

As the indium compound, it is possible to use indium oxide and indium hydroxide, for example. These indium compounds may be used alone in one type or in combination of two or more types.

The negative electrode of the alkaline battery according to the present invention is a gelled negative electrode, and contains a gelling agent and an alkaline electrolyte solution, in addition to the zinc alloy powder and the indium compound.

There is no specific limitation regarding the type of the gelling agent. It is possible to use a gelling agent used in conventional alkaline batteries, and examples thereof include various high polymer gelling agents such as carboxymethyl cellulose, polyacrylic acid, and sodium polyacrylate. The content of the gelling agent in the gelled negative electrode may be 1.5 to 3 mass % in mass ratio with respect to the entire negative electrode.

Furthermore, there is no specific limitation regarding the type of the alkaline electrolyte solution contained in the negative electrode. It is possible to use an alkaline electrolyte solution similar to that used in conventional alkaline batteries having a gelled negative electrode, and examples thereof include an aqueous solution of an alkali metal hydroxide such as potassium hydroxide and sodium hydroxide. Also, there is no specific limitation regarding the alkali concentration, and the alkali concentration may be 20 to 40 mass % in mass ratio with respect to the entire negative electrode, for example.

The gelled negative electrode can be prepared using a method in which zinc alloy powder and an alkaline electrolyte solution that has been gelled in advance using the gelling agent are mixed, for example. When the indium compound is used, it is possible that the zinc alloy powder and the indium compound are mixed in advance and then the mixture is mixed with the gelled alkaline electrolyte solution, or that the indium compound is added when the zinc alloy powder and the gelled alkaline electrolyte solution are mixed, for example. The gelled negative electrode may be prepared using methods other than the above.

It is desirable that the content of the zinc alloy powder in the gelled negative electrode is 60 mass % or more, more preferably 65 mass % or more, and 75 mass % or less, more preferably 70 mass % or less, in mass ratio with respect to the entire negative electrode, for example. Furthermore, when the indium compound is used, it is desirable that the content of the indium compound is 50 ppm or more, more preferably 100 ppm or more, and 500 ppm or less, more preferably 300 ppm or less, with respect to the total mass of the zinc alloy powder and the indium compound, for example.

Furthermore, it is sufficient that the alkaline battery according to the present invention contains the above-described gelled negative electrode, and there is no specific limitation regarding other configurations, and thus the configurations applied in conventional alkaline batteries (alkaline primary batteries) can be applied. For example, the positive electrode may contain a metal oxide such as manganese dioxide, oxy nickel hydroxide, and silver oxide as a positive electrode active material, and a conductive material such as graphite, acetylene black, and carbon black. An alkaline electrolyte solution further may be contained as in the negative electrode. As a separator, materials such as a nonwoven fabric made of synthetic resin fiber may be used. Furthermore, in addition to the alkaline electrolyte solution used for fabricating the electrode, an alkaline electrolyte solution further may be injected so that the separator, for example, is impregnated with it when the battery is being assembled. The alkaline electrolyte solution used for the electrode and the alkaline electrolyte solution used during the battery assembly may be the same, or different from each other in the alkali concentration.

Furthermore, the alkaline battery according to the present invention may be used for various applications in which conventional alkaline batteries (alkaline primary batteries) have been used, but in particular in an application for equipment such as a clock, in which the battery is required to be discharged until the voltage relatively becomes low, is preferable because the effect (effect of improving the discharge characteristics of the battery by increasing the utilization ratio of a zinc alloy) of the present invention is exerted remarkably.

Hereinafter, the present invention is described in detail based on examples, but the present invention is not limited to the following examples.

### Example 1

As the alkaline electrolyte solution, an aqueous solution was prepared in which the content of potassium hydroxide was 35 mass % and the content of zinc oxide was 2.4 mass %. Polyacrylic acid and sodium polyacrylate were added to the alkaline electrolyte solution such that each of their contents was 2 mass %, and thus a gelled alkaline electrolyte solution was prepared. Furthermore, as the zinc alloy powder, zinc alloy powder was used that was constituted by a zinc alloy containing aluminum: 600 ppm, bismuth: 150 ppm, and indium: 500 ppm, that contained particles with a particle size of 75 μm or less, in a mass ratio of 30 mass % of all the particles, and that entirely could pass through a sieve with 425 μm openings. Furthermore, indium hydroxide was added to the zinc alloy powder such that the content was 200 ppm in mass ratio with respect to the entire mixture. The gelled alkaline electrolyte solution and the zinc alloy powder containing the indium hydroxide were mixed in a mass ratio of 33.3:66.7, and thus a gelled negative electrode was prepared.

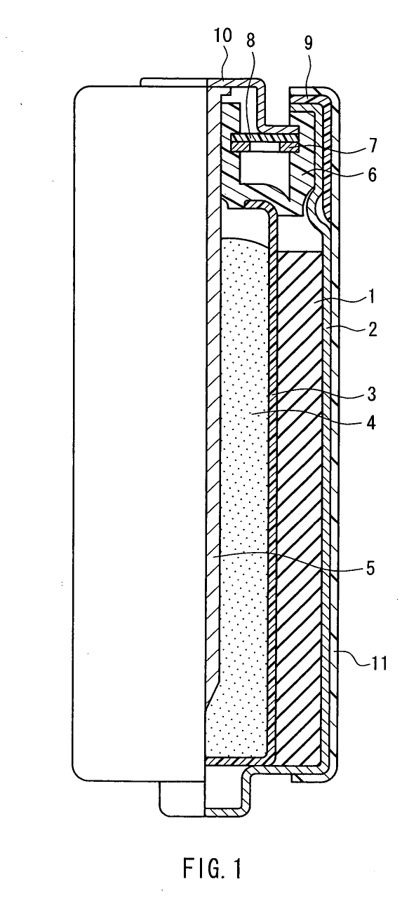

As the positive electrode, a positive electrode was used that contained manganese dioxide as an active material, and that was obtained by mixing the manganese dioxide and graphite (conductive material) in a mass ratio of 95:5 and molding this mixture into the shape of a ring. Furthermore, as the alkaline electrolyte solution during battery assembly, an aqueous solution containing 35 mass % of potassium hydroxide and 2.4 mass % of zinc oxide was used. Using the positive electrode, the gelled negative electrode, and the alkaline electrolyte solution, an AA-sized alkaline battery (alkaline primary battery) having the structure as shown in FIG. 1 was fabricated.

Herein, an alkaline battery shown in FIG. 1 is described. FIG. 1 is a partial cross-sectional view of an alkaline battery fabricated in this example. In FIG. 1, a positive electrode 1 is contained in a terminal-attached positive can 2. A portion inside the positive can 2 on the side of the internal circumference of the positive electrode 1 is filled with a gelled negative electrode 4 with a separator 3 interposed therebetween. Furthermore, the alkaline battery is provided with a negative current collector 5, a sealing member 6, a metal washer 7, a resin washer 8, an insulation cap 9, a negative terminal plate 10, and a resin outer package 11. The components described as the negative current collector 5 and the following have similar configurations to those applied in conventional alkaline primary batteries. Furthermore, as the separator 3, a nonwoven fabric made of vinylon and rayon is used. Although not shown in FIG. 1, the alkaline battery contains a gelled alkaline electrolyte solution used when preparing the gelled negative electrode, and a non-gelled alkaline electrolyte solution used when assembling the battery.

### Example 2

An alkaline battery was fabricated as in Example 1, except that as the zinc alloy constituting the zinc alloy powder, a zinc alloy containing aluminum: 1000 ppm, bismuth: 150 ppm, and indium: 500 ppm was used.

### Example 3

An alkaline battery was fabricated as in Example 1, except that as the zinc alloy constituting the zinc alloy powder, a zinc alloy containing aluminum: 2000 ppm, bismuth: 150 ppm, and indium: 500 ppm was used.

### Example 4

An alkaline battery was fabricated as in Example 1, except that as the zinc alloy constituting the zinc alloy powder, a zinc alloy containing aluminum: 3000 ppm, bismuth: 150 ppm, and indium: 500 ppm was used.

### Example 5

An alkaline battery was fabricated as in Example 2, except that as the zinc alloy powder, zinc alloy powder was used that contained particles with a particle size of 75 μm or less, in a mass ratio of 10 mass % of all the particles, and that entirely could pass through a sieve with 425 μm openings.

### Example 6

An alkaline battery was fabricated as in Example 2, except that as the zinc alloy powder, zinc alloy powder was used that contained particles with a particle size of 75 μm or less, in a mass ratio of 15 mass % of all the particles, and that entirely could pass through a sieve with 425 μm openings.

### Example 7

An alkaline battery was fabricated as in Example 2, except that as the zinc alloy powder, zinc alloy powder was used that contained particles with a particle size of 75 μm or less, in a mass ratio of 20 mass % of all the particles, and that entirely could pass through a sieve with 425 μm openings.

### Example 8

An alkaline battery was fabricated as in Example 2, except that as the zinc alloy powder, zinc alloy powder was used that contained particles with a particle size of 75 μm or less, in a mass ratio of 25 mass % of all the particles, and that entirely could pass through a sieve with 425 μm openings.

### Example 9

An alkaline battery was fabricated as in Example 2, except that as the zinc alloy powder, zinc alloy powder was used that contained particles with a particle size of 75 μm or less, in a mass ratio of 35 mass % of all the particles, and that entirely could pass through a sieve with 425 μm openings.

### Example 10

An alkaline battery was fabricated as in Example 2, except that as the zinc alloy powder, zinc alloy powder was used that contained particles with a particle size of 75 μm or less, in a mass ratio of 40 mass % of all the particles, and that entirely could pass through a sieve with 425 μm openings.

### Comparative Example 1

An alkaline battery was fabricated as in Example 1, except that as the zinc alloy constituting the zinc alloy powder, a zinc alloy containing aluminum: 30 ppm, bismuth: 150 ppm, and indium: 500 ppm was used.

### Comparative Example 2

An alkaline battery was fabricated as in Example 1, except that as the zinc alloy constituting the zinc alloy powder, a zinc alloy containing aluminum: 300 ppm, bismuth: 150 ppm, and indium: 500 ppm was used.

### Comparative Example 3

An alkaline battery was fabricated as in Example 1, except that as the zinc alloy constituting the zinc alloy powder, a zinc alloy containing aluminum: 4000 ppm, bismuth: 150 ppm, and indium: 500 ppm was used.

### Comparative Example 4

An alkaline battery was fabricated as in Example 2, except that as the zinc alloy powder, zinc alloy powder was used that contained particles with a particle size of 75 μm or less, in a mass ratio of 5 mass % of all the particles, and that entirely could pass through a sieve with 425 μm openings.

### Comparative Example 5

An alkaline battery was fabricated as in Example 2, except that as the zinc alloy powder, zinc alloy powder was used that contained particles with a particle size of 75 μm or less, in a mass ratio of 45 mass % of all the particles, and that entirely could pass through a sieve with 425 μm openings.

Batteries immediately after fabrication, and batteries that had been stored at 60° C. for 40 days, then was taken out of the storage, and have been left at 20° C. for one day, of Examples 1 to 10 and Comparative Examples 1 to 5, were discharged at 20° C., 500 mA, and the discharge durations were measured taking the final voltage as 0.7 V. The results are shown in Table 1. It should be noted that the discharge durations are shown as indexes when the discharge durations of the batteries in Comparative Example 1 in the respective conditions are taken as 100.

TABLE 1

| | | ratio (mass %) | | |
|---|---|---|---|---|
| | | of particles | | |
| | content (ppm) | with particle | discharge duration | |
| | of aluminum | size of | immediately | after |
| | in zinc alloy | 75 μm or | after | storage at |
| | of zinc | less in zinc | battery | 60° C. for |
| | alloy powder | alloy powder | fabrication | 40 days |
| Ex. 1 | 600 | 30 | 106 | 109 |
| Ex. 2 | 1000 | 30 | 114 | 112 |
| Ex. 3 | 2000 | 30 | 111 | 108 |
| Ex. 4 | 3000 | 30 | 108 | 103 |
| Ex. 5 | 1000 | 10 | 103 | 103 |
| Ex. 6 | 1000 | 15 | 105 | 105 |
| Ex. 7 | 1000 | 20 | 108 | 108 |
| Ex. 8 | 1000 | 25 | 111 | 111 |
| Ex. 9 | 1000 | 35 | 117 | 108 |
| Ex. 10 | 1000 | 40 | 119 | 103 |
| Com. Ex. 1 | 30 | 30 | 100 | 100 |
| Com. Ex. 2 | 300 | 30 | 101 | 102 |
| Com. Ex. 3 | 4000 | 30 | 105 | 95 |
| Com. Ex. 4 | 1000 | 5 | 100 | 100 |
| Com. Ex. 5 | 1000 | 45 | 121 | 98 |

As clearly shown in Table 1, the batteries in Examples 1 to 10 immediately after fabrication and after storage at 60° C. for 40 days had longer discharge durations, that is, better discharge characteristics than those of the batteries in Comparative Examples 1 to 5.

More specifically, the batteries in Examples 1 to 4 immediately after fabrication and after storage at 60° C. for 40 days had longer discharge durations, that is, better discharge characteristics than those of the batteries in Comparative Examples 1 and 2 in which the amount of aluminum in the zinc alloy constituting the zinc alloy powder was small. Furthermore, the battery in Comparative Example 3 in which the amount of aluminum in the zinc alloy constituting the zinc alloy powder was large had a short discharge duration after storage, that is, deteriorated discharge characteristics.

The batteries in Examples 2 and 5 to 10 immediately after fabrication and after storage at 60° C. for 40 days had longer discharge durations, that is, better discharge characteristics than those of the batteries in Comparative Example 4, which were formed using zinc alloy powder in which the ratio of particles with a particle size of 75 μm or less was low. Furthermore, the battery in Comparative Example 5, which was formed using zinc alloy powder in which the ratio of particles with a particle size of 75 μm or less was high, had a short discharge duration after storage, that is, deteriorated discharge characteristics.

The present invention may be embodied in other forms without departing from the gist thereof. The embodiments disclosed in this application are to be considered in all respects as illustrative and not limiting. The scope of the present invention is indicated by the appended claims rather than by the foregoing description, and all changes which come within the meaning and range of equivalency of the claims are intended to be embraced therein.

What is claimed is:

1. An alkaline battery, comprising a positive electrode, a negative electrode, and an alkaline electrolyte solution,
wherein the negative electrode contains zinc alloy powder, a gelling agent, and an alkaline electrolyte solution,
the zinc alloy powder is constituted by a zinc alloy containing 600 to 3000 ppm of aluminum, and
the zinc alloy powder contains particles with a particle size of 75 μm or less, in a mass ratio of 10 to 40 mass % of all the particles.

2. The alkaline battery according to claim 1,
wherein the negative electrode further contains an indium compound.

3. The alkaline battery according to claim 2,
wherein the indium compound is at least one selected from the group consisting of indium hydroxide and indium oxide.

4. The alkaline battery according to claim 2,
wherein a content of the indium compound is 50 to 500 ppm with respect to a total mass of the zinc alloy powder and the indium compound.

5. The alkaline battery according to claim 1,
wherein the negative electrode further contains an indium compound, and indium is segregated on a surface of the zinc alloy powder.

6. The alkaline battery according to claim 5,
wherein the indium compound is at least one selected from the group consisting of indium hydroxide and indium oxide.

7. The alkaline battery according to claim 5,
wherein a content of the indium compound is 50 to 500 ppm with respect to a total mass of the zinc alloy powder and the indium compound.

8. The alkaline battery according to claim 1,
wherein a content of the zinc alloy powder in the negative electrode is 60 to 75 mass % in mass ratio with respect to the entire negative electrode.

9. The alkaline battery according to claim 1,
wherein the gelling agent is at least one selected from the group consisting of carboxymethyl cellulose, polyacrylic acid, and sodium polyacrylate.

10. The alkaline battery according to claim 1,
wherein a content of the gelling agent in the negative electrode is 1.5 to 3 mass % in mass ratio with respect to the entire negative electrode.

11. The alkaline battery according to claim 1,
wherein the positive electrode contains a metal oxide and a conductive material.

12. The alkaline battery according to claim 11,
wherein the metal oxide is manganese dioxide.

13. The alkaline battery according to claim 11,
wherein the conductive material is graphite.

14. The alkaline battery according to claim 1,
wherein the alkaline electrolyte solution is an aqueous solution of an alkali metal hydroxide.

15. The alkaline battery according to claim 14,
wherein the alkali metal hydroxide is at least one selected from the group consisting of potassium hydroxide and sodium hydroxide.
